(19) United States
(12) Patent Application Publication
(10) Pub. No.: US 2026/0361823 A1
(43) Pub. Date: Nov. 12, 2026

(54) RECORDING DEVICE

(71) Applicant: SEIKO EPSON CORPORATION, Tokyo (JP)

(72) Inventors: Takuto TANAKA, SHIOJIRI-SHI (JP); Hiroyuki YODA, SHIOJIRI-SHI (JP); Hirofumi YANAGISAWA, SHIOJIRI-SHI (JP); Koji HARA, MATSUMOTO-SHI (JP); Masato OGAWA, SHIOJIRI-SHI (JP)

(21) Appl. No.: 19/673,968

(22) Filed: May 11, 2026

(30) Foreign Application Priority Data
May 12, 2025 (JP) 2025-079366

(51) Int. Cl. H04N 1/00; B41J 3/46; H04N 1/44

(52) U.S. Cl. CPC H04N 1/00496; B41J 3/46; H04N 1/4426; H04N 1/4433

(57) ABSTRACT

A recording device installed on an installation surface includes a recording section configured to record an image on a medium, a housing accommodating the recording section, an operation panel configured to change posture with respect to the housing and receive user input, and an authentication section arranged adjacent to the operation panel and having a placement surface on which an authentication terminal is placeable. The operation panel is pivotable between a tilting posture and a standing posture about a pivot shaft. The housing includes a front surface, a first side surface, and a second side surface opposite the first side surface. When viewed from the front surface, the operation panel is positioned closer to the second side surface than to the first side surface, and the placement surface is positioned closer to the first side surface than the operation panel, thereby improving visibility and accessibility for a user.

The present application is based on, and claims priority from JP Application Serial Number 2025-079366 filed May 12, 2025, the disclosure of which is hereby incorporated by reference herein in its entirety.

### BACKGROUND

### 1. Technical Field

The present disclosure relates to a recording device such as a printer.

### 2. Related Art

For example, as disclosed in JP-A-2011-203371, there is a copying machine as an example of a recording device. The copying machine includes an operation panel unit, which is an example of an operation panel. The operation panel unit is swingable about a rear side thereof as a pivot shaft so that a front side thereof is raised and lowered.

A card reader unit, which is an example of an authentication section, is mounted on the operation panel unit.

The card reader unit performs user authentication. In other words, the card reader unit reads identification information from an IC card, which is an example of an authentication terminal held by a user, and compares the read authentication information with authentication data. When the identification information matches the authentication data, the card reader unit permits the user to use the copying machine.

The card reader unit disclosed in JP-A-2011-203371 is provided on the outer side in the width direction of the operation panel unit. Therefore, even when the user stands in front of the recording device and tries to perform user authentication, it may be difficult to view the authentication section depending on the angle of the operation panel.

### SUMMARY

A recording device that solves the above-described problem is configured to be installed on an installation surface and includes a recording section configured to record an image on a medium; a housing configured to accommodate the recording section; an operation panel configured to change a posture with respect to the housing and to receive a user operation related to an operation of the recording section; and an authentication section arranged adjacent to the operation panel and having a placement surface on which an authentication terminal is placeable, wherein the operation panel is changeable, by pivoting about a pivot shaft, between a tilting posture in which an angle relative to the installation surface is a first angle and a standing posture in which an angle relative to the installation surface is a second angle larger than the first angle, the housing has a front surface, a first side surface, and a second side surface on a side opposite the first side surface, and when viewed from the front surface, the operation panel is arranged at a position closer to the second side surface than to the first side surface and a distance between the placement surface and the first side surface is shorter than a distance between the operation panel and the first side surface.

### BRIEF DESCRIPTION OF THE DRAWINGS

FIG. 1 is a perspective view of an embodiment of a recording device.

FIG. 2 is a schematic side view of an operation panel and an authentication section.

FIG. 3 is a schematic side view of an operation panel and an authentication section included in a recording device according to a modification.

### DESCRIPTION OF EMBODIMENTS

### Embodiments

Hereinafter, an embodiment of a recording device will be described with reference to the drawings. The recording device is, for example, an inkjet printer that performs printing by ejecting ink, which is an example of a liquid, onto a medium such as a paper sheet, fabric, vinyl, a plastic part, a metal part or the like.

### Recording device

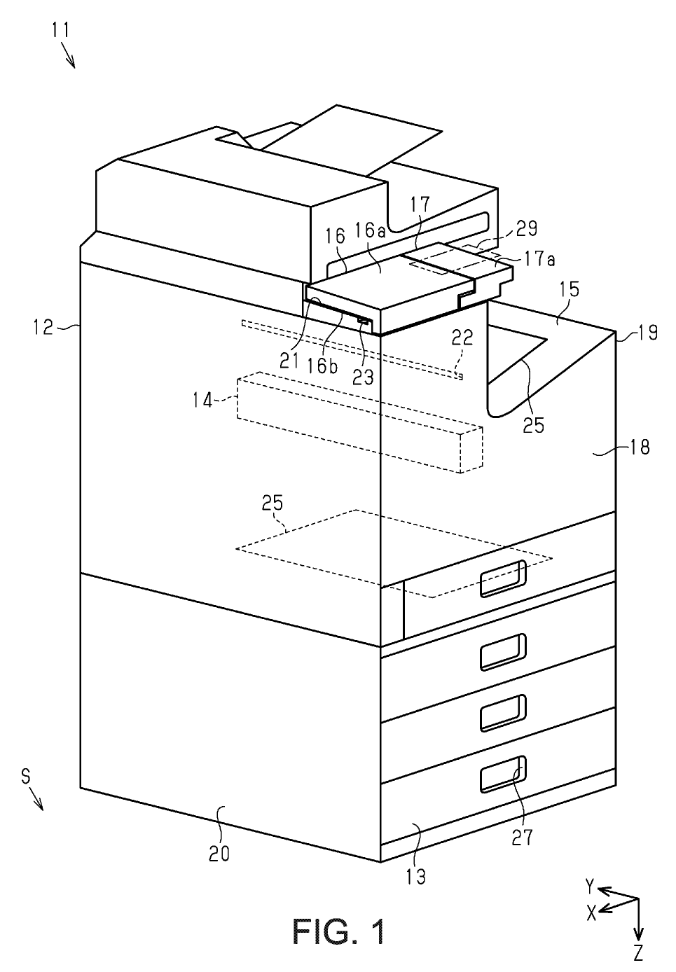

As illustrated in FIG. 1, a recording device 11 can be installed on an installation surface S. In the drawings, the direction of gravity is indicated by a Z-axis and directions along a horizontal plane are indicated by an X-axis and a Y-axis on the assumption that the installation surface S is a horizontal plane. The X-axis, the Y-axis, and the Z-axis are orthogonal to each other. In the following description, a direction parallel to the X-axis is also referred to as a width direction X, a direction parallel to the Y-axis is also referred to as a depth direction Y, and a direction parallel to the Z-axis is also referred to as a vertical direction Z.

The recording device 11 may include a housing 12, one or more medium accommodation section 13, a recording section 14, a stacker 15, an operation panel 16, and an authentication section 17.

The housing 12 accommodates various configurations of the recording device 11. The housing 12 accommodates the recording section 14. The housing 12 may have a front surface 18, a first side surface 19, a second side surface 20, an facing surface 21, and a discharge port 22.

The front surface 18 is a surface on the front side in the depth direction Y. The first side surface 19 and the second side surface 20 are surfaces located on both sides in the width direction X. The second side surface 20 is a surface on the opposite side of the first side surface 19. The first side surface 19 and the second side surface 20 intersect with the ends of the front surface 18. The facing surface 21 faces the operation panel 16 and the authentication section 17. The facing surface 21 is located below the operation panel 16 and the authentication section 17.

The recording device 11 may have a groove section 23. The groove section 23 may be provided on the facing surface 21.

The groove section 23 may extend in the width direction X. The groove section 23 may extend from an end on the first side surface 19 side to an end on the second side surface 20 side. The groove section 23 may extend in the width direction X from the end on the second side surface 20 side of the operation panel 16 to the end on the first side surface 19 side of the authentication section 17.

The medium accommodation section 13 can accommodate one or more medium 25. The medium accommodation section 13 may accommodate a bundle of the medium 25 before printing. The medium accommodation section 13 is, for example, a cassette. The medium accommodation section 13 is provided so as to be drawable from the front surface 18. The medium accommodation section 13 may include a handle section 27. The user can easily pull out the medium accommodation section 13 by hooking a hand on the handle section 27.

The recording section 14 records an image on the medium 25. The recording section 14 may perform recording on the medium 25 by ejecting liquid from a nozzle (not illustrated). The medium 25 on which recording has been performed is discharged from the discharge port 22. The discharge port 22 is located above the lower end of the stacker 15. The discharge port 22 is opened toward the stacker 15. The stacker 15 receives the medium 25 discharged from the discharge port 22.

The operation panel 16 receives a user operation related to the operation of the recording section 14. The operation panel 16 may include a touch panel for operating the recording device 11, or may include buttons and the like. When viewed from the front surface 18, the operation panel 16 is arranged at a position closer to the second side surface 20 than to the first side surface 19. The position of the end of the operation panel 16 on the second side surface 20 side may be aligned with the second side surface 20. The operation panel 16 may have an upper surface 16a and a first rear surface 16b. The upper surface 16a is a surface operated by the user. The first rear surface 16b is a surface opposite to the upper surface 16a. The first rear surface 16b faces the facing surface 21. The first rear surface 16b may be in contact with the facing surface 21.

The authentication section 17 has a placement surface 17a. The placement surface 17a is a surface on which an authentication terminal 29 can be placed. The authentication terminal 29 is a terminal that stores identification information for identifying a specific individual, for example. The authentication section 17 can read the identification information from the authentication terminal 29 placed on the placement surface 17a. The authentication section 17 may read the identification information from the authentication terminal 29 brought close to the placement surface 17a. The authentication terminal 29 is, for example, a card, a tag, a smartphone, or the like. The recording device 11 may permit or restrict the use of the recording device 11 according to the read identification information.

The authentication section 17 is provided adjacent to the operation panel 16. The authentication section 17 and the operation panel 16 are arranged side by side in the width direction X. The authentication section 17 is arranged between the first side surface 19 and the operation panel 16 in the width direction X. In the width direction X, a distance between the placement surface 17a and the first side surface 19 is shorter than a distance between the operation panel 16 and the first side surface 19. In the width direction X, a distance between the placement surface 17a and the second side surface 20 is longer than a distance between the operation panel 16 and the second side surface 20. A part of the placement surface 17a may be located at the center of the housing 12 in the width direction X. A part of the placement surface 17a may be located at the same position as the discharge port 22 in the width direction X. At least a part of the placement surface 17a may be located at the same position as the stacker 15 in the width direction X. At least a part of the placement surface 17a may be located at the same position as the handle section 27 in the width direction X.

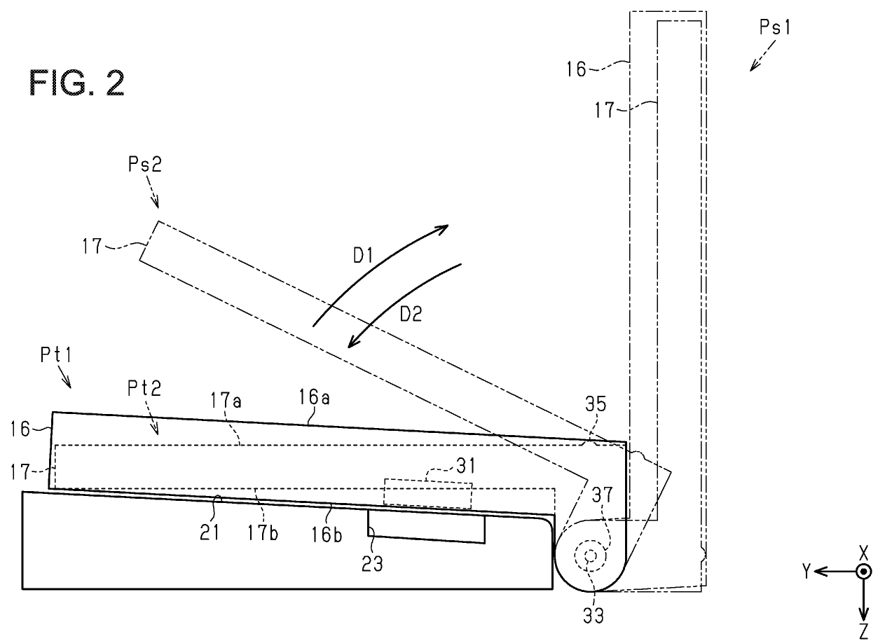

As illustrated in FIG. 2, the authentication section 17 may have a second rear surface 17b. The second rear surface 17b is a surface opposite to the placement surface 17a. The second rear surface 17b faces the facing surface 21. The second rear surface 17b may be in contact with the facing surface 21.

The recording device 11 may include a speaker 31. The speaker 31 may be provided on the operation panel 16. The speaker 31 may be provided on the first rear surface 16b. The speaker 31 may face the groove section 23.

The posture of the operation panel 16 can be changed with respect to the housing 12. The posture of the authentication section 17 can be changed with respect to the housing 12. The operation panel 16 and the authentication section 17 pivot about a pivot shaft 33. The pivoting refers to rotation about an axis in which the rotatable angle of rotation is less than 360 degrees. The operation panel 16 and the authentication section 17 of the present embodiment pivot about the same pivot shaft 33. The operation panel 16 and the authentication section 17 may pivot about different pivot shafts 33.

The operation panel 16 is changeable between the first tilting posture Pt1 and the first standing posture Ps1 by pivoting about the pivot shaft 33. The first tilting posture Pt1 is a posture in which an angle with the installation surface S is a first angle. In the first tilting posture Pt1, the angle of the upper surface 16a with respect to the installation surface S may be a first angle. The first standing posture Ps1 is a posture in which an angle with the installation surface S is a second angle larger than the first angle. In the first standing posture Ps1, the angle of the upper surface 16a with respect to the installation surface S may be a second angle. The first standing posture Ps1 may be such that the upper surface 16a is perpendicular to the installation surface S. The operation panel 16 in the first tilting posture Pt1 is pivoted in a first pivoting direction D1, which is an example of a pivoting direction, to be in the first standing posture Ps1. The operation panel 16 in the first standing posture Ps1 is rotated in the second pivoting direction D2 to be in the first tilting posture Pt1. The second pivoting direction D2 is opposite to the first pivoting direction D1.

The authentication section 17 is changeable between the second tilting posture Pt2 and the second standing posture Ps2 by pivoting about the pivot shaft 33. The second tilting posture Pt2 is a posture in which an angle with the installation surface S is a third angle. In the second tilting posture Pt2, the angle of the placement surface 17a with respect to the installation surface S is a third angle. The third angle is smaller than the first angle. In the authentication section 17 in the second tilting posture Pt2, the placement surface 17a may be parallel to the installation surface S. The second standing posture Ps2 is a posture in which the angle with the installation surface S is a fourth angle larger than the third angle. The fourth angle is smaller than the second angle. Therefore, the authentication section 17 in the second standing posture Ps2 is more tilted than the operation panel 16 in the first standing posture Ps1. The placement surface 17a of the second tilting posture Pt2 may be located below the upper surface 16a of the operation panel 16 of the first tilting posture Pt1. A part of the placement surface 17a of the second tilting posture Pt2 may be located below the upper surface 16a of the operation panel 16 of the first tilting posture Pt1.

The authentication section 17 may have a rib 35. The rib 35 protrudes from the placement surface 17a. When the authentication section 17 is in the second tilting posture Pt2, the rib 35 and the pivot shaft 33 may be positioned in front of the center of the placement surface 17a in the depth direction Y.

The recording device 11 may include an interlocking section 37. The interlocking section 37 interlocks the operation panel 16 and the authentication section 17 so that they pivot. The interlocking section 37 may change the pivoting range of the authentication section 17. The interlocking section 37 may change the pivoting range of the authentication section 17 depending on whether the user pivots the authentication section 17 or pivots the operation panel 16.

When the user pivots either the authentication section 17 or the operation panel 16 in the first pivoting direction D1, the interlocking section 37 interlocks the authentication section 17 and the operation panel 16. In detail, when the user pivots the authentication section 17 in the first pivoting direction D1, the interlocking section 37 pivots the operation panel 16 in the first pivoting direction D1 in accordance with the pivoting of the authentication section 17. At this time, the interlocking section 37 enables the authentication section 17 and the operation panel 16 to pivot to the second angle. That is, the authentication section 17 can take the first standing posture Ps1 together with the operation panel 16.

When the user pivots the operation panel 16 in the first pivoting direction D1, the interlocking section 37 rotates the authentication section 17 in the first pivoting direction D1 in accordance with the pivoting of the operation panel 16. At this time, the interlocking section 37 makes the pivoting range of the authentication section 17 smaller than the second angle. For example, when the operation panel 16 in the first tilting posture Pt1 is pivoted to the first standing posture Ps1, the authentication section 17 in the second tilting posture Pt2 may stop at the second standing posture Ps2.

When the user pivots the operation panel 16 in the second pivoting direction D2, the interlocking section 37 may pivot the authentication section 17 in the second pivoting direction D2 in accordance with the pivoting of the operation panel 16. When the user rotates the authentication section 17 in the second pivoting direction D2, the interlocking section 37 may pivot the operation panel 16 in the second pivoting direction D2 in accordance with the pivoting of the authentication section 17.

### Operation of the present embodiment

The operation of the present embodiment will be explained.

As illustrated in FIG. 1, the operation panel 16 is arranged at a position close to the second side surface 20. The authentication section 17 is arranged between the operation panel 16 and the first side surface 19. The operation panel 16 does not hide the authentication section 17 from the user facing the recording device 11. Therefore, the risk that the user forgets to place the authentication terminal 29 on the placement surface 17a is reduced. When the user places the authentication terminal 29 on the authentication section 17 while the terminal is suspended from the user's neck, the risk of a neck strap attached to the authentication terminal 29 becoming caught on the operation panel 16 is reduced.

### Effects of the present embodiment

Effects according to the present embodiment will be described.

(1-1) A distance between the placement surface 17a and the first side surface 19 is shorter than a distance between the operation panel 16 and the first side surface 19. In other words, the second side surface 20, the operation panel 16, the placement surface 17a, and the first side surface 19 are arranged in this order. The operation panel 16 is arranged at a position closer to the second side surface 20 than to the first side surface 19. Therefore, when the user faces the front surface 18, the placement surface 17a is located at a position closer to the user than the operation panel 16. Therefore, the user authentication can be easily performed.

(1-2) The authentication section 17 can change the posture between the second tilting posture Pt2 and the second standing posture Ps2. Therefore, for example, the user can change the posture of the placement surface 17a to a posture in which the authentication terminal 29 are easily placed.

(1-3) The fourth angle is smaller than the second angle. In other words, the second standing posture Ps2 of the authentication section 17 is a posture that is more tilted than the first standing posture Ps1 of the operation panel 16. Therefore, even when the authentication terminal 29 is placed on the authentication section 17 in the second standing posture Ps2, the risk of the authentication terminal 29 falling can be reduced.

(1-4) The third angle is smaller than the first angle. The authentication section 17 in the second tilting posture Pt2 has a step with respect to the operation panel 16 in the first tilting posture Pt1. Therefore, even when the authentication terminal 29 placed on the authentication section 17 in the second tilting posture Pt2 moves closer to the operation panel 16, the risk of the authentication terminal 29 falling from the placement surface 17a can be reduced.

(1-5) The interlocking section 37 interlocks the authentication section 17 and the operation panel 16 so that they pivot. The interlocking section 37 changes the pivoting range of the authentication section 17 depending on which of the authentication section 17 and the operation panel 16 is pivoted. When the user pivots the authentication section 17, the authentication section 17 and the operation panel 16 can pivot to the second angle. Therefore, the operation panel 16 can be easily set to the first standing posture Ps1 by pivoting the authentication section 17 located at a position close to the user. When the operation panel 16 is pivoted, the interlocking section 37 makes the pivoting range of the authentication section 17 smaller than the second angle. Therefore, it is possible to reduce the risk that the authentication terminal 29 placed on the authentication section 17 falls.

(1-6) When the authentication section 17 is in the second tilting posture Pt2, the rib 35 and the pivot shaft 33 are positioned on the front side. Therefore, when the authentication section 17 in the second tilting posture Pt2 is pivoted toward the second standing posture Ps2, the rib 35 is positioned below the center of the placement surface 17a. Therefore, even if the authentication terminal 29 placed on the placement surface 17a slips, the slip can be stopped by the rib 35.

(1-7) The placement surface 17aof the authentication section 17 in the second tilting posture Pt2 is located below the upper surface 16a of the operation panel 16 in the first tilting posture Pt1. Since the placement surface 17ahas a step with respect to the operation panel 16, even when the authentication terminal 29 moves so as to approach the operation panel 16, it is possible to reduce the risk that the authentication terminal 29 falls from the placement surface 17a.

(1-8) The groove section 23 facing the speaker 31 extends from the end of the operation panel 16 on the second side surface 20 side to the end of the authentication section 17 on the first side surface 19 side. Therefore, it is possible to easily pass the sound of the speaker 31 located at the first rear surface 16b.

### Modifications

The present embodiment can be implemented with the following modifications. The present embodiments and the following modifications can be implemented in combination with each other as long as there is no technical contradiction.

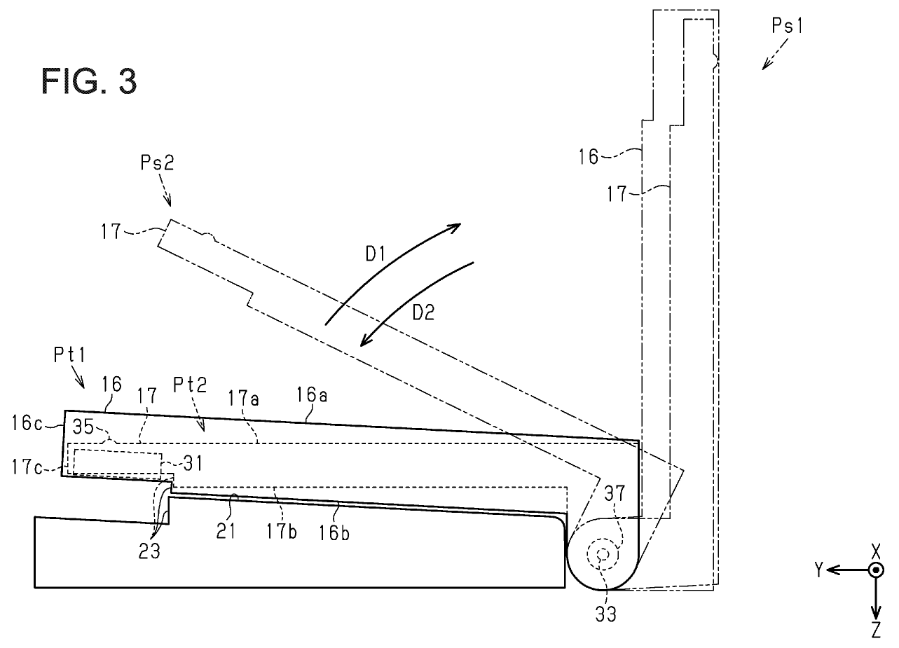

As illustrated in FIG. 3, when the authentication section 17 is in the second tilting posture Pt2, the pivot shaft 33 may be positioned in front of the center of the placement surface 17a in the depth direction Y. When the placement surface 17ais in the second tilting posture Pt2, the rib 35 may be positioned on the rear side, with respect to the center of the placement surface 17a in the depth direction Y. When the placement surface 17a is in the second tilting posture Pt2, the rib 35 is arranged at the rear side. Therefore, even if the authentication terminal 29 placed on the placement surface 17a slides to the rear side, the rib 35 can stop the authentication terminal 29.

As illustrated in FIG. 3, the groove section 23 may be provided in each of the first rear surface 16b, the second rear surface 17b, and the facing surface 21. The groove section 23 may be provided in a first tip end 16c of the operation panel 16. The first tip end 16cis an end on the opposite side of the pivot shaft 33. The groove section 23 may be arranged at a position facing the first tip end 16c in the facing surface 21. The groove section 23 may be arranged in a second tip end 17cof the authentication section 17. The second tip end 17c is an end on the opposite side of the pivot shaft 33. The groove section 23 may be provided at a position facing the second tip end 17c in the facing surface 21. When the user rotates the operation panel 16 and the authentication section 17, the user can easily pivot the operation panel 16 and the authentication section 17 by putting his/her hand on a position away from the pivot shaft 33. On that point, the groove section 23 is located at the first tip end 16c and the second tip end 17c, which are on the side opposite to the pivot shaft 33. Therefore, it is possible to easily put a hand on the operation panel 16 and the authentication section 17.

The groove section 23 may be arranged in at least one of the first rear surface 16b, the second rear surface 17b, and the facing surface 21. For example, the groove section 23 may be arranged in the first rear surface 16b and the second rear surface 17b. The groove section 23 may be arranged obliquely with respect to the width direction X. The recording device 11 may be configured not to include the groove section 23.

The speaker 31 may be arranged on the facing surface 21. The speaker 31 may be arranged in the authentication section 17. The speaker 31 may be arranged in the groove section 23. The speaker 31 may be arranged at a position different from the operation panel 16, the authentication section 17, and the facing surface 21. The recording device 11 may be configured not to include the speaker 31.

The placement surface 17a of the authentication section 17 in the second tilting posture Pt2 may be arranged above the upper surface 16a of the operation panel 16 in the first tilting posture Pt1. In the vertical direction Z, the placement surface 17a of the authentication section 17 in the second tilting posture Pt2 and the upper surface 16a of the operation panel 16 in the first tilting posture Pt1 may be arranged at the same position. The third angle of the authentication section 17 in the second tilting posture Pt2 may be the same as or larger than the first angle of the operation panel 16 in the first tilting posture Pt1.

The placement surface 17a of the authentication section 17 in the second standing posture Ps2 may be arranged above or in front of the upper surface 16a of the operation panel 16 in the first standing posture Ps1. The placement surface 17a of the authentication section 17 in the second standing posture Ps2 and the upper surface 16a of the operation panel 16 in the first standing posture Ps1 may be aligned with each other. The fourth angle of the authentication section 17 in the second standing posture Ps2 may be the same as or larger than the second angle of the operation panel 16 in the first standing posture Ps1.

The rib 35 may extend in the depth direction Y when the authentication section 17 is in the second tilting posture Pt2.

The authentication section 17 may include a plurality of ribs 35. The authentication section 17 may include a bent or curved rib 35. The authentication section 17 may not include the rib 35. For example, the placement surface 17a may have a recess.

The interlocking section 37 may not change the pivoting range of the authentication section 17. Even when the user pivots the authentication section 17 in the first pivoting direction D1, the authentication section 17 may pivot between the second tilting posture Pt2 and the second standing posture Ps2.

The recording device 11 may be configured not to include the interlocking section 37. The authentication section 17 and the operation panel 16 may pivot independently.

The authentication section 17 may be configured not to pivot.

The recording device 11 is not limited to an inkjet type printer, and may be a laser printer, a thermal printer, a dot impact printer, a digital printing machine, or the like.

The recording device may be a liquid ejection device that performs recording by ejecting or discharging liquid other than ink. The state of liquid that is ejected from the liquid ejection device as a minute amount of liquid droplets includes a granular shape, a tear shape, and a shape with a thread-like tail. Here, the liquid may be a material that can be ejected from the liquid ejection device. For example, a liquid may be any state in which a substance is in a liquid phase, and includes fluids such as high or low viscosity liquids, sols, gel water, other inorganic solvents, organic solvents, solutions, liquid resins, liquid metals, and metal melts. The liquid includes not only a liquid as one state of a substance but also a liquid in which particles of a functional material made of a solid material such as a pigment or metal particles are dissolved, dispersed, or mixed in a solvent. Typical examples of the liquid include ink as described in the above embodiment and liquid crystal. Here, the ink includes various liquid compositions such as general water-based ink, oil-based ink, gel ink, and hot-melt ink. As a specific example of the liquid ejection device, there is a device that ejects liquid containing materials such as electrode materials or color materials used for manufacturing liquid crystal displays, electroluminescence displays, surface-emitting displays, color filters, or the like, in a dispersed or dissolved form. The liquid ejection device may be a device that ejects a bioorganic substance used for manufacturing a biochip, a device that is used as a precision pipette and ejects liquid serving as a sample, a textile printing device, a micro dispenser, or the like. The liquid ejection device may be a device that ejects lubricating oil to precision machinery such as watches or cameras in a pinpoint manner, or a device that ejects a transparent resin liquid such as an ultraviolet curable resin onto a substrate in order to form micro hemispherical lenses, optical lenses, or the like used in optical communication elements or the like. The liquid ejection device may be a device for ejecting an etching liquid such as an acid or an alkali for etching a substrate or the like.

### Definitions

As used herein, the phrase "at least one" means "one or more" of the desired alternatives. As an example, the phrase "at least one" as used herein means "only one option" or "both of two options" if the number of options is two. As another example, as used herein, the phrase "at least one" means "only one option", "a combination of two options", or "a combination of three or more options" if the number of options is three or more.

### Appendix

Hereinafter, technical ideas and operational effects thereof grasped from the above-described embodiment and modifications will be described.

[1] A recording device is configured to be installed on an installation surface and includes a recording section configured to record an image on a medium; a housing configured to accommodate the recording section; an operation panel configured to change a posture with respect to the housing and to receive a user operation related to an operation of the recording section; and an authentication section arranged adjacent to the operation panel and having a placement surface on which an authentication terminal is placeable, wherein the operation panel is changeable, by pivoting about a pivot shaft, between a tilting posture in which an angle relative to the installation surface is a first angle and a standing posture in which an angle relative to the installation surface is a second angle larger than the first angle, the housing has a front surface, a first side surface, and a second side surface on a side opposite the first side surface, and when viewed from the front surface, the operation panel is arranged at a position closer to the second side surface than to the first side surface and a distance between the placement surface and the first side surface is shorter than a distance between the operation panel and the first side surface.

According to this configuration, a distance between the placement surface and the first side surface is shorter than a distance between the operation panel and the first side surface. In other words, the second side surface, the operation panel, the placement surface, and the first side surface are arranged in this order. The operation panel is arranged at a position closer to the second side surface than to the first side surface. Therefore, when the user faces the front surface, the placement surface is arranged at a position closer to the user than the operation panel. Therefore, the user authentication can be easily performed.

[2] The recording device according to [1] may be configured such that when the tilting posture is defined as a first tilting posture and the standing posture is defined as a first standing posture, the authentication section is changeable, by pivoting, between a second tilting posture in which the angle with respect to the installation surface is a third angle, and a second standing posture in which the angle with respect to the installation surface is a fourth angle greater than the third angle.

According to this configuration, the authentication section can change its posture between the second tilting posture and the second standing posture. Therefore, for example, the user can change the posture of the placement surface to a posture in which the authentication terminal is easily placed.

[3] The recording device according to [2] may be configured such that the fourth angle is smaller than the second angle.

According to this configuration, the fourth angle is smaller than the second angle. In other words, the second standing posture of the authentication section is a posture that is more tilted than the first standing posture of the operation panel. Therefore, even when the authentication terminal is placed on the authentication section in the second standing posture, the risk of the authentication terminal falling can be reduced.

[4] The recording device according to [2] may be configured such that the third angle is smaller than the first angle.

According to this configuration, the third angle is smaller than the first angle. The authentication section in the second tilting posture has a step with respect to the operation panel in the first tilting posture. Therefore, even when the authentication terminal placed on the authentication section in the second tilting posture moves so as to approach the operation panel, it is possible to reduce the risk of the authentication terminal falling from the placement surface.

[5] The recording device according to any one of [2] to [4] may further include an interlocking section configured to pivot the authentication section in interlocked movement with the operation panel, wherein the operation panel in the first tilting posture is pivoted in a pivoting direction to be in the first standing posture, the authentication section in the second tilting posture pivots about the pivot shaft in the pivoting direction to be in the second standing posture, and the interlocking section is configured to change a pivoting range of the authentication section, when the user pivots the authentication section in the pivoting direction and moves the operation panel in interlocked movement with the authentication section, enable the authentication section to rotate to the second angle, and when the user pivots the operation panel in the pivoting direction and moves the operation panel in interlocked movement with the authentication section, set the pivoting range of the authentication section to be smaller than the second angle.

According to this configuration, the interlocking section interlocks the authentication section and the operation panel so that they pivot. The interlocking section changes the pivoting range of the authentication section depending on whether the authentication section or the operation panel is pivoted. When the user pivots the authentication section, the authentication section and the operation panel are pivotable to the second angle. Therefore, the operation panel can be easily set to the first standing posture by pivoting the authentication section located at a position close to the user. When the operation panel is pivoted, the interlocking section makes the pivoting range of the authentication section smaller than the second angle. Therefore, it is possible to reduce the risk that the authentication terminal placed on the authentication section falls.

[6] The recording device according to any one of [2] to [5] may be configured such that the authentication section includes a rib that pivots about a pivot shaft and protrudes from the placement surface and when the authentication section is in the second tilting posture, the rib and the pivot shaft are arranged forward of a center of the placement surface in the depth direction.

According to this configuration, when the authentication section is in the second tilting posture, the rib and the pivot shaft are located on the front side.

Therefore, when the authentication section in the second tilting posture is pivoted toward the second standing posture, the rib is located below the center of the placement surface. Therefore, even if the authentication terminal placed on the placement surface slips, the rib can stop the authentication terminal.

[7] The recording device according to any one of [2] to [6] may be configured such that the authentication section includes a rib that pivots about a pivot shaft and protrudes from the placement surface and when the authentication section is in the second tilting posture, the pivot shaft is arranged forward of the center of the placement surface in the depth direction and when the placement surface is in the second tilting posture, the rib is arranged at a rear side of a center of the placement surface in the depth direction.

According to this configuration, when the placement surface is in the second tilting posture, the rib is located on the rear side. Therefore, even if the authentication terminal placed on the placement surface slips rear side, the authentication terminal can be stopped by the rib.

[8] The recording device according to any one of [2] to [7] may be configured such that the placement surface of the authentication section in the second tilting posture is arranged below the upper surface of the operation panel in the first tilting posture.

According to this configuration, the placement surface of the authentication section in the second tilting posture is located below the upper surface of the operation panel in the first tilting posture. Since the placement surface has a step relative to the operation panel, even when the authentication terminal moves toward the operation panel, it is possible to reduce the risk of the authentication terminal falling from the placement surface.

[9] The recording device according to any one of [1] to [8] may be configured such that the operation panel includes a first rear surface, the authentication section includes a second rear surface, the recording device further includes a speaker that is arranged on the first rear surface, a facing surface that opposes the first rear surface and the second rear surface, and a groove section on at least one of the first rear surface, the second rear surface, and the facing surface, the groove section extends, in a width direction, from an end on a second-side-surface side of the operation panel to an end on a first-side-surface side of the authentication section, and the speaker faces the groove section.

According to this configuration, the groove section facing the speaker extends from the end of the operation panel on the second-side-surface side to the end of the authentication section on the first-side-surface side. Therefore, it is possible to easily pass the sound of the speaker located on the first rear surface.

The recording device according to [9] may be configured such that the groove section is provided on either a first tip end of the operation panel, which is an end opposite the pivot shaft, or on a position on the facing surface that faces the first tip end and on either a second tip end of the authentication section, which is an end opposite the pivot shaft, or on a position on the facing surface that faces the second tip end.

When the user pivots the operation panel and the authentication section, the user can easily pivot the operation panel and the authentication section by putting his/her hand on a position away from the pivot shaft. In this regard, according to this configuration, the groove section is located at the first and second tip ends, which are opposite the pivot shaft. Therefore, the operation panel and the authentication section can be easily accessed.

What is claimed is:

1. A recording device configured to be installed on an installation surface, the recording device comprising:
a recording section configured to record an image on a medium;
a housing configured to accommodate the recording section;
an operation panel configured to change a posture with respect to the housing and to receive a user operation related to an operation of the recording section; and
an authentication section arranged adjacent to the operation panel and having a placement surface on which an authentication terminal is placeable, wherein
the operation panel is changeable, by pivoting about a pivot shaft, between a tilting posture in which an angle relative to the installation surface is a first angle and a standing posture in which an angle relative to the installation surface is a second angle larger than the first angle,
the housing has a front surface, a first side surface, and a second side surface on a side opposite the first side surface, and
when viewed from the front surface,
the operation panel is arranged at a position closer to the second side surface than to the first side surface and
a distance between the placement surface and the first side surface is shorter than a distance between the operation panel and the first side surface.

2. The recording device according to claim 1, wherein
when the tilting posture is defined as a first tilting posture and the standing posture is defined as a first standing posture,
the authentication section is changeable, by pivoting, between a second tilting posture in which the angle with respect to the installation surface is a third angle, and a second standing posture in which the angle with respect to the installation surface is a fourth angle greater than the third angle.

3. The recording device according to claim 2, wherein
the fourth angle is smaller than the second angle.

4. The recording device according to claim 2, wherein
the third angle is smaller than the first angle.

5. The recording device according to claim 2, further comprising:
an interlocking section configured to pivot the authentication section in interlocked movement with the operation panel, wherein
the operation panel in the first tilting posture is pivoted in a pivoting direction to be in the first standing posture,
the authentication section in the second tilting posture pivots about the pivot shaft in the pivoting direction to be in the second standing posture, and
the interlocking section is configured to
change a pivoting range of the authentication section,
when the user pivots the authentication section in the pivoting direction and moves the operation panel in interlocked movement with the authentication section, enable the authentication section to rotate to the second angle, and
when the user pivots the operation panel in the pivoting direction and moves the operation panel in interlocked movement with the authentication section, set the pivoting range of the authentication section to be smaller than the second angle.

6. The recording device according to claim 2, wherein
the authentication section includes a rib that pivots about a pivot shaft and protrudes from the placement surface and
when the authentication section is in the second tilting posture, the rib and the pivot shaft are arranged forward of a center of the placement surface in the depth direction.

7. The recording device according to claim 2, wherein
the authentication section includes a rib that pivots about a pivot shaft and protrudes from the placement surface and
when the authentication section is in the second tilting posture, the pivot shaft is arranged forward of the center of the placement surface in the depth direction and
when the placement surface is in the second tilting posture, the rib is arranged at a rear side of a center of the placement surface in the depth direction.

8. The recording device according to claim 2, wherein
the placement surface of the authentication section in the second tilting posture is arranged below the upper surface of the operation panel in the first tilting posture.

9. The recording device according to claim 1 wherein
the operation panel includes a first rear surface,
the authentication section includes a second rear surface, the recording device further includes
a speaker that is arranged on the first rear surface,
a facing surface that opposes the first rear surface and the second rear surface, and
a groove section on at least one of the first rear surface, the second rear surface, and the facing surface,
the groove section extends, in a width direction, from an end on a second-side-surface side of the operation panel to an end on a first-side-surface side of the authentication section, and
the speaker faces the groove section.

10. The recording device according to claim 9, wherein
the groove section is provided
on either a first tip end of the operation panel, which is an end opposite the pivot shaft, or on a position on the facing surface that faces the first tip end and
on either a second tip end of the authentication section, which is an end opposite the pivot shaft, or on a position on the facing surface that faces the second tip end.

11. The recording device according to claim 1, wherein
the authentication section includes a first surface facing the operation panel, and
the first surface is arranged at a position closer to the second side surface than to the first side surface.
